(19) United States
(12) Patent Application Publication
(10) Pub. No.: US 2006/0060703 A1
(43) Pub. Date: Mar. 23, 2006

(54) Three dimensional seating arrangement to increase seating capacity

(76) Inventor: Fong Luk, Alameda, CA (US)

Correspondence Address: Bo-Ln Lin, 13445 Mandoli Drive, Los Altos Hills, CA, 94022, US

(21) Appl. No.: 10/948,419

(22) Filed: Sep. 22, 2004

(51) Int. Cl. B64D 11/00

(52) U.S. Cl. 244/118.5

(57) ABSTRACT

A method for arranging a plurality of seats in a moving vehicle, e.g., an airplane cabinet, is disclosed in this invention. The method includes a step of arranging at least two adjacent seats having two different elevation levels relative to a floor of said airplane cabinet. In a preferred embodiment, seats between two adjacent rows in the airplane cabinet having two different elevation levels. In another preferred embodiment, the method further includes a step of providing a space below a row of seats having a higher elevation to store a luggage therein.

### BACKGROUND OF THE INVENTION

1. Field of the Invention

This invention relates generally to the seat arrangements in a limited space. More particularly, this invention relates to a three-dimensional arrangement of seats to increase the seating capacity and to increase the level of comfort by providing more legroom and luggage storage space for passengers in an airplane.

2. Description of the Prior Art

Conventional seats in an airplane are arranged according to a two dimensional layout. As shown in FIG. 1, all the seats 10 are placed on a same floor level 20 and all the seats 10 have a same height. According to this two-dimensional arrangement, the seating capacity is fixed once the size of the seats and the space between the seats are defined. In order to increase the seating capacity on an airplane, the size of the seats and/or the space between the seats are reduced in order to squeeze more people into a fixed space arranged according to this two-dimensional layout. However, once the size of the seat is reduced and the legal room is shrunken, the comfort level of the passenger suffers. Therefore, a comprise must be made between the economical goal to pack more people in each flight to reduce the transportation cost versus the concern that if passenger's comfort level is reduced, people may chose to fly with other airlines thus losing the business due a seat layout that allows too little space to each passenger.

Therefore, there is still a demand in the art of commercial airline design to provide new and improved seat arrangement such that more efficient space utilization may be achieved.

### SUMMARY OF THE PRESENT INVENTION

It is therefore an object of the present invention to provide a new and improved arrangement of seats to optimize the space utilization by arranging the seats over a three-dimensional space. The seats are arranged to have different elevation levels in the airplane cabinet such that the seating capacity can be increased and passengers are allowed more space with a higher comfort level such that the above-mentioned difficulties and limitations can be overcome.

Specifically, it is an object of the present invention to provide a new and improved arrangement of seats by making adjacent rows of seats to have different elevations such that the space between two rows of neighboring seats are extended over different horizontal planes and the space utilization is improved.

In a preferred embodiment, this invention discloses a method for arranging a plurality of seats in an airplane cabinet. The method includes a step of arranging at least two adjacent seats having two different elevation level relative to a floor of said airplane cabinet. In a preferred embodiment, seats between two adjacent rows in the airplane cabinet having two different elevation levels. In another preferred embodiment, the method further includes a step of providing a space below a row of seats having a higher elevation to store a luggage therein.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1 is a side view for illustrating a conventional seat arrangement.

FIG. 2 is a side view for illustrating a new and improved three-dimensional arrangement of seats to increase the space utilization.

FIG. 3 is another side view for illustrating another three-dimensional seat arrangement of this invention.

FIG. 4 is another side view for illustrating another preferred embodiment by elevating every other row of seats to increase the legroom that is easy and more economic to implement.

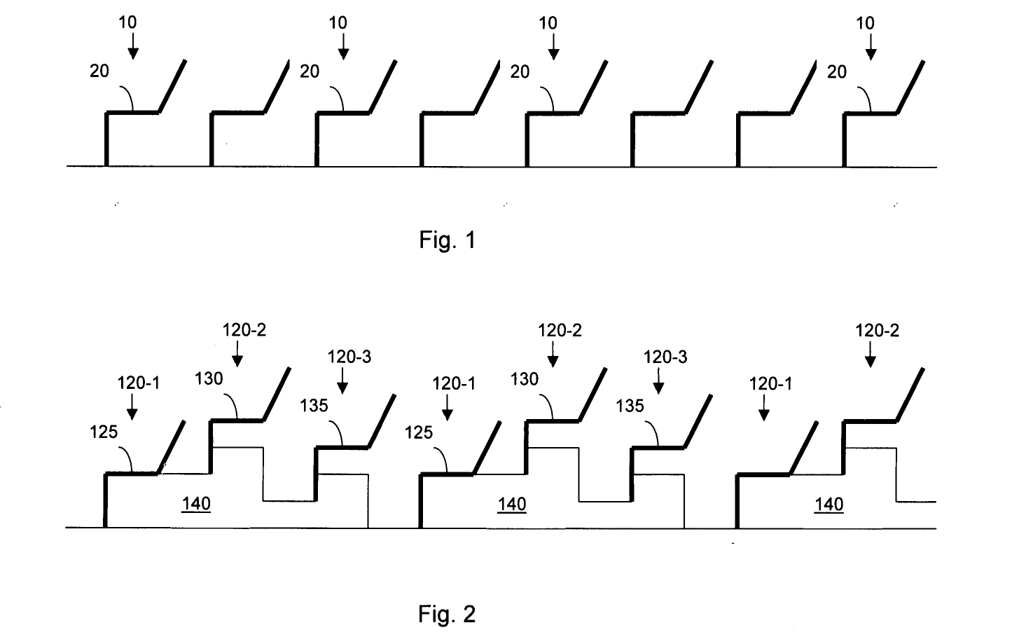

### DETAILED DESCRIPTION OF THE PREFERRED EMBODIMENT

Referring to FIG. 2 for side view of the seat arrangement as a first preferred embodiment of this invention. As shown in FIG. 2, every three rows of seats are arranged to have different elevation. A first row 120-1 is placed on a floor elevation 125, a second row 120-2 is placed at a top, i.e., a highest elevation 130, a third row is placed at a medium elevation 135. As shown in the FIG. 2, under the elevated seats 120-2 and 120-3, there are spaces 140 allowed for luggage storage. The passengers now seating on the seats with different elevations have more legroom. Furthermore, the seating capacity in a fixed and limited space in the airline cabinet can be further increased.

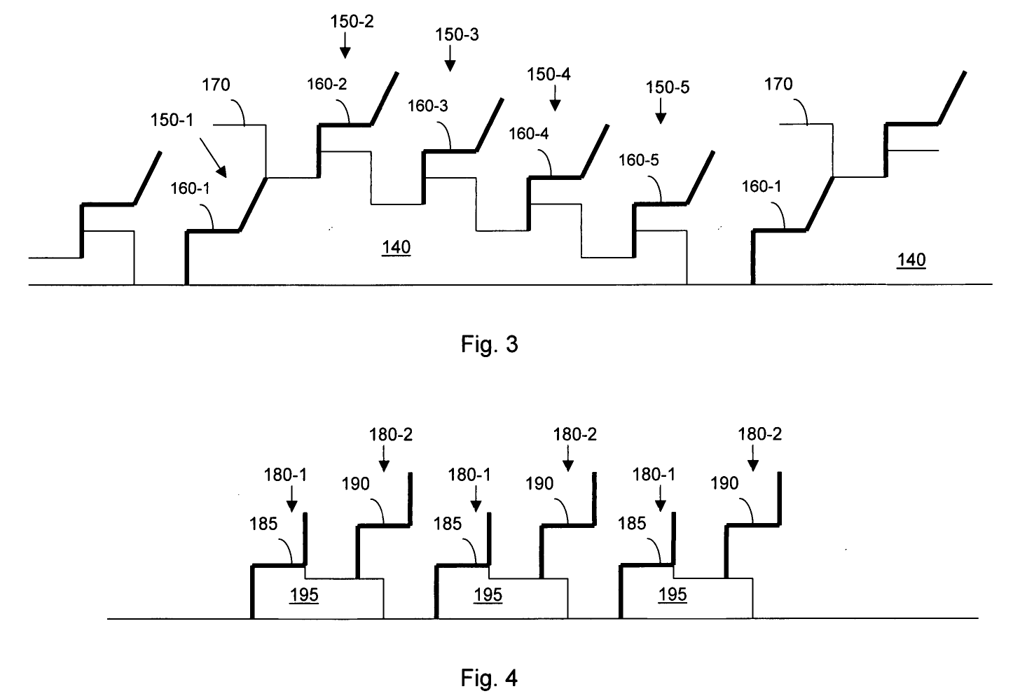

FIG. 3 is another preferred embodiment wherein the five rows of seats, i.e., 150-1, to 150-5, are arranged to have different elevations, i.e., 160-1 to 150-5. The seats with a lowest, e.g, 150-1, elevation further have a cover platform 170 to allow a passenger seating on the seats 15-2 more space as personal useable spaces.

Therefore, an arrangement of plurality of seats in an airplane cabinet is disclosed wherein at least two adjacent seats are placed on two different elevation levels. Specifically, the seats are arranged into a multiple rows and two adjacent rows of seats having two different elevation levels. In a preferred embodiment, a space underneath a seat having a higher elevation to allow for a storage space. In another preferred embodiment, two adjacent rows of seats having two different elevation levels and a fixed number of rows having a repeated pattern of an elevation profile arrangement. In another preferred embodiment, one of the rows having a covering platform Referring to FIG. 4 for side view of the seat arrangement as another preferred embodiment of this invention. As shown in FIG. 4, every adjacent row of seats are arranged to have different elevation. A first row 180-1 is placed on a floor elevation 185, a second row 180-2 is placed at a higher elevation 190. As shown in the FIG. 2, under the elevated seats 180-2 there are spaces 195 to allow for luggage storage. The passengers now seating on the seats with different elevations have more legroom. Furthermore, the seating arrangement can be conveniently implemented by elevated only half of the rows in an existing airplane cabinet. This configuration can be easily economically implemented to achieve the benefit of increasing seating capacity to reduce the operation cost and increase the profit of operating an airline.

A plurality of seats placed in a cabinet of a moving vehicle is therefore disclosed in this invention that includes t least two adjacent seats are placed on two different elevation levels. In a preferred embodiment, the seats are arranged into a multiple rows and two adjacent rows of seats having two different elevation levels. In another preferred embodiment, the plurality of seats further includes a space underneath a seat having a higher elevation to allow for a storage space. In another preferred embodiment, the seats are arranged into a multiple rows wherein two adjacent rows of seats having two different elevation levels and a fixed number of rows having a repeated pattern of an elevation profile arrangement. In another preferred embodiment, the seats are arranged into a multiple rows and one of the rows having a covering platform.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

1. A plurality of seats placed in an airplane cabinet wherein:
at least two adjacent seats are placed on two different elevation levels.

2. The plurality of seats of claim 1 wherein:
said seats are arranged into a multiple rows and two adjacent rows of seats having two different elevation levels.

3. The plurality of seats of claim 1 further comprising:
a space underneath a seat having a higher elevation to allow for a storage space.

4. The plurality of seats of claim 1 wherein:
said seats are arranged into a multiple rows wherein two adjacent rows of seats having two different elevation levels and a fixed number of rows having a repeated pattern of an elevation profile arrangement.

5. The plurality of seats of claim 1 wherein:
said seats are arranged into a multiple rows and one of said rows having a covering platform.

6. A method for arranging a plurality of seats in an airplane cabinet comprising:
arranging at least two adjacent seats having two different elevation level relative to a floor of said airplane cabinet.

7. The method of claim 6 further comprising:
arranging said seats are into a multiple rows and arranging two adjacent rows of seats with two different elevation levels.

8. The method of claim 6 further comprising:
providing a space underneath a seat having a higher elevation to allow for a storage space.

9. The method of claim 6 further comprising:
arranging said seats are into a multiple rows with two adjacent rows of seats having two different elevation levels and arranging a fixed number of rows to have a repeated pattern of an elevation profile arrangement.

10. The method of claim 6 further comprising:
arranging said seats are into a multiple rows and providing a cover-platform for one of said rows.

11. A plurality of seats placed in an airplane cabinet arranged into a plurality of rows wherein:
two adjacent rows of seats are placed on two different elevation levels.

12. The plurality of seats of claim 1 wherein:
said rows of seats are arranged into two different elevations.

13. A plurality of seats placed in a cabinet of a moving vehicle wherein:
at least two adjacent seats are placed on two different elevation levels.

14. The plurality of seats of claim 1 wherein:
said seats are arranged into a multiple rows and two adjacent rows of seats having two different elevation levels.

15. The plurality of seats of claim 1 further comprising:
a space underneath a seat having a higher elevation to allow for a storage space.

16. The plurality of seats of claim 1 wherein:
said seats are arranged into a multiple rows wherein two adjacent rows of seats having two different elevation levels and a fixed number of rows having a repeated pattern of an elevation profile arrangement.

17. The plurality of seats of claim 1 wherein:
said seats are arranged into a multiple rows and one of said rows having a covering platform.
